(19) United States
(12) Patent Application Publication
(10) Pub. No.: US 2025/0256210 A1
(43) Pub. Date: Aug. 14, 2025

(54) GAMING MATCHMAKING SYSTEM

(71) Applicant: TM8 GAMING, LLC, Gainesville, FL (US)

(72) Inventor: Joshua Robert Gergley, Gainesville, FL (US)

(21) Appl. No.: 19/052,914

(22) Filed: Feb. 13, 2025

Related U.S. Application Data
(60) Provisional application No. 63/552,898, filed on Feb. 13, 2024.

(51) Int. Cl. A63F 13/795; A63F 13/798

(52) U.S. Cl. CPC A63F 13/795; A63F 13/798

(57) ABSTRACT

A gaming matchmaking platform designed to receive gameplay data, matchmaking data, user data, and other data relevant to online multiplayer gaming. The gaming matchmaking system correlates user input, gameplay style, and gameplay results to generate a comprehensive matchmaking system that improves a player's gaming experience. The gaming matchmaking system includes a mobile application that enables profile matching and team building for a plurality of users.

### CROSS-REFERENCE TO RELATED APPLICATIONS

This application is related to and claims priority to U.S. provisional patent application No. 63/552,898, filed on Feb. 13, 2024, the entire contents of which is incorporated by reference herein in its entirety.

### BACKGROUND

Millions of individuals play online multiplayer games on a daily basis. Given the variety of skills and games, it is difficult to provide matchmaking that accurately determines a player's skill and creates balanced matches.

### TECHNICAL FIELD

The present disclosure is generally directed to multiplayer gaming, more specifically to improving the matchmaking capabilities of multiplayer video games.

### DESCRIPTION OF RELATED ART

Online multiplayer games typically have players start at a low rank and force players to spend numerous hours ranking up. In some multiplayer video games, the first games played on a new account are given more weight as the game attempts to determine a player's skill level. This results in players being put in matches that have too high or too low of a skill level and can result in poor matchmaking for other players.

Another problem faced by current gaming algorithms is stat padding. For example, in some multiplayer games, an individual's score directly correlates to an amount of experience earned. This results in independent and selfish gaming behavior by many players that are focused on ranking up instead of working cooperatively as a team.

Yet another problem with current gaming matchmaking is away from keyboard (AFK) players and non-communicative players. These players can have minimal participation in their matchmaking, thereby increasing the burden on their team. This is particularly disadvantageous in team-based games that require coordination and participation from team members.

Another problem with matchmaking for some multiplayer games is that the only factor for ranking up or down is the result of a match. Although, this may result in more coordination between teammates, it can prevent a player from reaching their true rank because teammates vary from game to game. If a player is put on a team that has players at the incorrect skill level or lacks coordination, it can be difficult to win, thereby preventing players from ranking up. In view of the foregoing problems, there is a need for a gaming matchmaking system that accurately determines a player's skill level without negatively affecting the gaming experience.

### BRIEF SUMMARY

In some embodiments, a gaming matchmaking system designed to receive gameplay data, matchmaking data, user data, and other data relevant to multiplayer gaming is disclosed. Advantageously, the gaming matchmaking system is able to correlate user input, gameplay style, and gameplay results to generate a comprehensive matchmaking system that improves a player's gaming experience. In some embodiments, the gaming matchmaking system includes a mobile application and/or web application that is displayable via a user interface of a remote device. The mobile application and/or web application enables profile matching and team building for a plurality of users.

In some embodiments, a gaming matchmaking system is disclosed. The gaming matchmaking system includes an algorithm designed to prioritize specific matchmaking criteria and gradually broaden criteria within a predetermined range of attributes. Advantageously, this improves timeliness of matchmaking and user satisfaction while providing a dynamic matchmaking environment that adapts to player availability.

In some embodiments, a gaming matchmaking system including a weighted matchmaking algorithm is disclosed. The algorithm is designed to apply strict enforcement of gaming criteria and gradually broaden the criteria based on user preferences and results. For example, and without limitation, the algorithm is designed to search for other users that have identical preferences and/or skills to a targeted user profile. If a match is not found after a predetermined amount of time (e.g., three to five seconds), the algorithm loosens the criteria to find a close but not exact match (e.g., matchmaking score greater than 0.7). For further example, and without limitation, the gaming matchmaking system generates a matchmaking score based on (1) self-assessment, (2) game mode, (3) number of players, (4) in-game playstyle (e.g., offensive/defense, rotation), and (5) preferred playstyle (e.g., aggressive, non-aggressive). In some embodiments, the gaming matchmaking system, in addition to binary classification, includes sliders and/or ranges for tailoring a user matchmaking score. For example, and without limitation, using a slider, a user can select between beginner and intermediate, resulting in the gaming matchmaking system searching for players near the selected skill level.

In some embodiments, the gaming matchmaking system disclosed herein is configured for optimized matchmaking using user data and/or gameplay data. The gaming matchmaking system can comprise software instructions stored in a memory. The software can be stored in a non-transitory computer-readable medium capable of storing instructions. The instructions, when executed by one or more processors, can cause the one or more processors to perform one or more of the tasks described herein. In an embodiment of the present disclosure, the gaming matchmaking system can include a one or more instructions stored in a non-transitory computer-readable medium. The one or more instructions, that when executed by one or more processors, may cause the one or more processors to analyze user data and gameplay data associated with a user for a multiplayer game and provide a recommendation for changes to a user profile and improvements to user gameplay.

In an embodiment of the present disclosure, a gaming matchmaking system is disclosed. The gaming matchmaking system includes at least one remote device and a computer system communicatively coupled to the at least one remote device. The computer system includes a memory and at least one processor. The at least one processor can receive user data and gameplay data associated with at least one user from the at least one remote device. The at least one processor can further associate the user data with the gameplay data. The at least one processor can further generate a matchmaking score based on the association of the user data with the gameplay data. The at least one processor can further recommend at least one other user based on the matchmaking score.

In some embodiments, the user data can include the type of games played, amount of time played per game, a rank for each game, a rank for each game mode, and a type of role. The gameplay data may include audiovisual data and metadata corresponding to the audiovisual data. The metadata corresponding to the audiovisual data may include a gaming platform, gaming style, system requirements, controller settings, and/or a difficulty level. The at least one processor may further generate at least one gameplay recommendation based on the user data and the gameplay data. The at least one gameplay recommendation can include a controller recommendation, a playstyle recommendation, and/or an equipment recommendation.

In some embodiments, a multiplayer matchmaking system is disclosed. The multiplayer matchmaking system may include at least one remote device including a user interface, at least one gaming platform, and/or at least one remote server including a software platform including an analytics engine and at least one database. The at least one remote device, the at least gaming platform, and the at least one remote server can be in network communication. The at least one remote device can receive user input via the user interface. The at least one gaming platform can capture gameplay data corresponding to at least one user. The gameplay data may be transmitted to the at least one remote device and the at least one remote server. After receiving the user gameplay data, the analytics engine can analyze the user gameplay data and the user input data to determine a matchmaking score. Based on the matchmaking score, the analytics engine can suggest at least one matchmaking recommendation.

In some embodiments, the at least one matchmaking recommendation includes profile information corresponding to at least one other user. In some embodiments, the analytics engine can generate a gameplay recommendation. In some embodiments, the gameplay recommendation includes a playstyle recommendation and/or a setting recommendation. In some embodiment, the at least one remote device and the at least one gaming platform can receive the at least one matchmaking recommendation. The ta least one remote device can identify another user corresponding to the least one matchmaking recommendation. The at least one remote device may automatically generate a messaging request based on the identified user.

In some embodiments, the at least one remote server can receive real-time gameplay data corresponding to the at least one user. The analytics engine may automatically update the matchmaking score based on the real-time gameplay data. The analytics engine can generate a teammate recommendation based on the updated matchmaking score. In some embodiments, the gaming matchmaking system can include an artificial intelligence engine. The artificial intelligence engine can generate at least one coaching recommendation based on the user gameplay data. The analytics engine can generate a matchmaking score based on a user self-assessment, a game mode selection, a number of players, an in-game playstyle, and/or a playstyle preference. In some embodiments, the gameplay data includes movement data, positioning data, result data, and/or equipment data. The at least one matchmaking recommendation may include at least one teammate recommendation and/or at least one opponent recommendation. The gameplay data may include audiovisual data and metadata corresponding to the audiovisual data. The metadata may include gaming platform data, gaming style data, system requirements, controller settings, and/or difficulty level.

In some embodiments the at least one remote server can transmit the at least one matchmaking recommendation to the at least one remote device and/or the at least one gaming platform. The at least one remote device can identify other users corresponding to the at least one matchmaking recommendation. The at least one gaming console can automatically add the identified user to a team corresponding to the at least one user. In some embodiments, the at least one remote server can identify a third user based on the at least one matchmaking recommendation. The at least one gaming console and/or remote server can automatically add the third user to an opposing team of the at least one user.

### BRIEF DESCRIPTION OF THE SEVERAL VIEWS OF THE DRAWINGS

The embodiments illustrated, described, and discussed herein are illustrative of the present disclosure. As these embodiments of the present disclosure are described with reference to illustrations, various modifications or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present disclosure, and through which these teachings have advanced the art, are considered to be within the spirit and scope of the present disclosure. Hence, these descriptions and drawings should not be considered in a limiting sense, as it is understood that the present disclosure is in no way limited to only the embodiments illustrated.

FIG. 1 illustrates a schematic diagram of a gaming matchmaking system according to an embodiment of the present disclosure.

FIG. 2 illustrates a schematic diagram of a gaming matchmaking system according to an embodiment of the present disclosure.

FIG. 3 illustrates a dashboard of a gaming matchmaking system according to an embodiment of the present disclosure.

FIG. 4 illustrates a dashboard of a gaming matchmaking system according to an embodiment of the present disclosure.

FIG. 5 illustrates a dashboard of a gaming matchmaking system according to an embodiment of the present disclosure.

FIG. 6 illustrates a schematic diagram of a gaming matchmaking system according to an embodiment of the present disclosure.

FIG. 7 illustrates a schematic diagram of a remote server of a gaming matchmaking system according to an embodiment of the present disclosure.

FIG. 8 illustrates a schematic diagram of a personal computer of a gaming matchmaking system according to an embodiment of the present disclosure.

FIG. 9 illustrates a schematic diagram of a mobile device of a gaming matchmaking system according to an embodiment of the present disclosure.

FIG. 10 illustrates a schematic diagram of an internet-of-things (IoT) device of a gaming matchmaking system according to an embodiment of the present disclosure.

### DETAILED DESCRIPTION

For the purposes of promoting an understanding of the present disclosure, reference will be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e., at least one) of the grammatical object of the article. By way of example, “a composite” means at least one composite and can include more than one composite.

Throughout the specification, the terms “about” and/or “approximately” may be used in conjunction with numerical values and/or ranges. The term “about” is understood to mean those values near to a recited value. For example, “about 40 [units]” may mean within +/−25% of 40 (e.g., from 30 to 50), within +/−20%, +/−15%, +/−10%, +/−9%, +/−8%, +/−7%, +/−6%, +/−5%, +/−4%, +/−3%, +/−2%, +/−1%, less than +/−1%, or any other value or range of values therein or there below. Furthermore, the phrases “less than about [a value]” or “greater than about [a value]” should be understood in view of the definition of the term “about” provided herein. The terms “about” and “approximately” may be used interchangeably.

As used herein, the verb “comprise” as is used in this description and in the claims and its conjugations are used in its non-limiting sense to mean that items following the word are included, but items not specifically mentioned are not excluded.

Throughout the specification the word “comprising,” or variations such as “comprises” or “comprising,” will be understood to imply the inclusion of a stated element, integer or step, or group of elements, integers, or steps, but not the exclusion of any other element, integer or step, or group of elements, integers or steps. The present disclosure may suitably “comprise”, “consist of”, or “consist essentially of”, the steps, elements, and/or reagents described in the claims.

It is further noted that the claims may be drafted to exclude any optional element. As such, this statement is intended to serve as antecedent basis for use of such exclusive terminology as “solely”, “only”, and the like in connection with the recitation of claim elements, or the use of a “negative” limitation.

Unless defined otherwise, all technical and scientific terms used herein have the same meanings as commonly understood by one of ordinary skill in the art to which this disclosure belongs. Preferred methods, devices, and materials are described, although any methods and materials similar or equivalent to those described herein can be used in the practice or testing of the present disclosure. All references cited herein are incorporated by reference in their entirety.

In some embodiments, a gaming matchmaking system designed for enabling the socialization of gaming experiences and users is disclosed. The gaming matchmaking system includes a software platform including a matchmaking engine, an artificial intelligence engine, and a social engine. The gaming matchmaking system is in network communication with at least one remote device and/or at least one remote server including a database. The at least one remote device includes, but is not limited to, a cellphone, a laptop, a gaming console (e.g., PlayStation 5, Xbox Series X), a tablet, a desktop computer, and other similar remote devices. The database includes gaming data including but not limited to gameplay audiovisual files, user preferences and accounts, data corresponding to video games (e.g., mobile games, console games, computer games) and other data related to video games.

The gaming matchmaking system is designed to create user accounts corresponding to the gaming matchmaking system. The gaming matchmaking system is operable to correlate a user account with at least one third-party account. For example, and without limitation, the third-party account includes a Gmail account, a Microsoft account, an Apple account, a Steam account, a PlayStation account, and other similar third-party accounts. After receiving correct login credentials, the gaming matchmaking system is designed to retrieve user account data stored in a remote server including at least one database. The gaming matchmaking system is further operable to generate a home dashboard via a remote device corresponding to the at least one user. If the login credentials are incorrect, then the gaming matchmaking system is operable to generate a prompt for a user to try again. The gaming matchmaking system is further operable to prompt a user to reset their password and/or transmit a one-time password (OTP) to an email or remote device corresponding to the user account.

The gaming matchmaking system is further operable to monitor and analyze user gameplay data via the matchmaking engine. User gameplay data includes the type of games that a user plays, the amount of time that a user plays each game, a rank for each game, a rank for each game mode in a game, types of roles played (e.g., support, passive) by a user in each game, and other gameplay statistics. The gaming matchmaking system can analyze a plurality of games. For example, and without limitation, the plurality of games include multiplayer games, first-person shooters (FPS), massive multiple online games, single-player games, a role playing game (RPG), a massively multiplayer online role-playing game (MMORPG), sandbox, real-time strategy (RTS), multiplayer online battle arena (MOBA), simulation, sports, puzzlers, party games, action-adventure, survival and horror, and platformers. After receiving user credentials corresponding to a gaming platform (Xbox, PlayStation, Nintendo, Steam, Epic), the gaming matchmaking system automatically updates the gameplay data of a user account. The gaming matchmaking system receives gaming data corresponding to a user's gaming library for each gaming platform and corresponding amount of time spent playing.

The gaming matchmaking system is designed to generate a community feed populated by users on the gaming matchmaking system. The community feed includes videos, text, and audio files. Each user is operable to upload video, texts, and/or audio files directly from a remote device. The gaming matchmaking system is operable to filter and limit the community feed based on user preferences. For example, and not limitation, user preferences include types of games, selected user accounts, and other similar filter options. The gaming matchmaking system automatically generates alerts or notifications based on the user preferences. For example, and not limitation, the gaming matchmaking system transmits a notification to a user device when a new video about Spider-man for the PlayStation 5 is uploaded by a user account.

The gaming matchmaking system further includes a friend dashboard. The gaming matchmaking system is operable to display a list of friends corresponding to a user account. The gaming matchmaking system generates friend recommendations based on user gameplay including gaming interest, mutual friends, and other gameplay data. Each user account corresponding to the gaming matchmaking system includes a unique identifier. The unique identifier is searchable via the gaming matchmaking system. The gaming matchmaking system further generates recommendations for players to fill a user's team and team that are looking for players. The gaming matchmaking system further includes messaging functionality that supports the transmission of messages between a plurality of users. The gaming matchmaking system is operable to search a messaging history between one or more users.

The gaming matchmaking system can include customizable profile settings and profile data. The profile settings include, but are not limited to, a communication method (e.g., headset, call, chat), a region (e.g., North America, Europe, Africa, Asia, Oceania), an audio introduction (e.g., uploaded user voice), and profile picture (e.g., virtual avatar). The profile data can include user statistics corresponding to playtime, video clips, achievements, and other similar gaming data.

The gaming matchmaking system can further include an artificial intelligence engine. For example, and not limitation, the artificial intelligence engine is designed for natural language processing. The artificial intelligence engine is operable to automatically transmit electronic communications (e.g., chat messages) in response to a user prompt. The artificial intelligence component further receives and analyzes user account data and generates recommendations and analysis in response to the user account data. For example, and not limitation, the artificial intelligence engine is operable to receive video footage corresponding to user gameplay and to generate a video response that identifies user mistakes and recommendations for improving upon the user mistakes. For further example, the artificial intelligence engine is operable to receive communication data (e.g., voice communications, chat messages) and correlate the communication data with gameplay visual data to generate a matchmaking recommendation.

The artificial intelligence engine is operable to receive real-time, near real-time, and/or historical gameplay data. The artificial intelligence engine includes a visualization component for displaying the captured and analyzed real-time, near real-time, and/or historical gameplay data. The artificial intelligence engine is operable to generate a coaching recommendation based on user gameplay. For example, and without limitation, the artificial intelligence engine is operable to receive user gameplay data corresponding to Rocket League. The gameplay data includes movement data, positioning data, and other gameplay data corresponding to at least one Rocket League match. The artificial intelligence engine is operable to compare the movement data, positioning data, boost management data, equipment data (e.g., type of vehicle), and speed data for other players. In some aspects, the artificial intelligence engine compares a target user performance to performances of other players in the same match. In some aspects, the artificial intelligence engine compares user gameplay data to users with similar ranks, playstyles, and/or other characteristics related to the gameplay. The artificial intelligence engine can further compare user performance against similar opponents. After analyzing the gameplay data, the artificial intelligence engine is operable to generate a coaching recommendation including (1) rotate back post, (2) work on speed aerials, (3) collect small boost pads instead of going for large boost pads and other analysis relevant to the user's gameplay. The coaching recommendation can be game-specific but can also be related to multiple games. For example, and without limitation, the artificial intelligence engine is operable to track user behavior for a plurality of first-person shooter (FPS) games. Based on user mouse movement and weapon accuracy, the artificial intelligence engine is designed to suggest whether a user should increase or decrease a dots per inch (DPI) corresponding to a user's mouse. The artificial intelligence engine is further operable to recommend changes to user settings. For example, and without limitation, if a user is using a wireless controller, the artificial intelligence engine may suggest switching to a wired connection to reduce input latency. For further example, the artificial intelligence engine is operable to detect that a user is experiencing significant latency (e.g., greater than 100 ping) during online matchmaking and confirm whether a user is connected to a proper server based on the user location. If the artificial intelligence engine further detects that the user is experiencing issues that are not directed related to user gameplay, the artificial intelligence engine is designed to not affect a matchmaking score.

In some embodiments, the gaming matchmaking system can suggest a type of role (e.g., tank, support, offensive, defensive) for a user to try when playing a new game. For example, and without limitation, if a user has achieved a high rank playing a support role in a team-based shooter, the artificial intelligence engine is operable to suggest one or more support characters that have similar gameplay designs in a separate game.

In some embodiments, the artificial intelligence engine can include a plurality of artificial intelligence learning techniques including, but not limited to, machine learning (ML), regression, classification, transfer learning, clustering, natural language processing (NLP), computer vision, deep learning, dimensionality reduction, word embeddings, support vector machines and reinforcement learning.

In some embodiments, the gaming matchmaking system is operable for real-time streaming and betting. The gaming matchmaking system is operable to transmit real-time gameplay footage corresponding to a video game match. The gaming matchmaking system is operable to receive wagers before and during the match. For example, and without limitation, a player can wager on themselves prior to a 1v1 match, a 2v2 match, and/or a 3v3 match. The gaming matchmaking system is operable to receive match results and player data via a third-party source. The match data includes match results, player stats, session-based information, and ranking updates.

In some embodiments, the game matchmaking system is operable to suggest an opponent. The suggested opponent may be based on similar ranks, user preference for a challenge, and other user and/or gameplay information. The game matchmaking system is further operable to generate betting odds for a match. For example, and without limitation, the game matchmaking system generates odds based on user rankings, matchmaking scores, and bets made by other users.

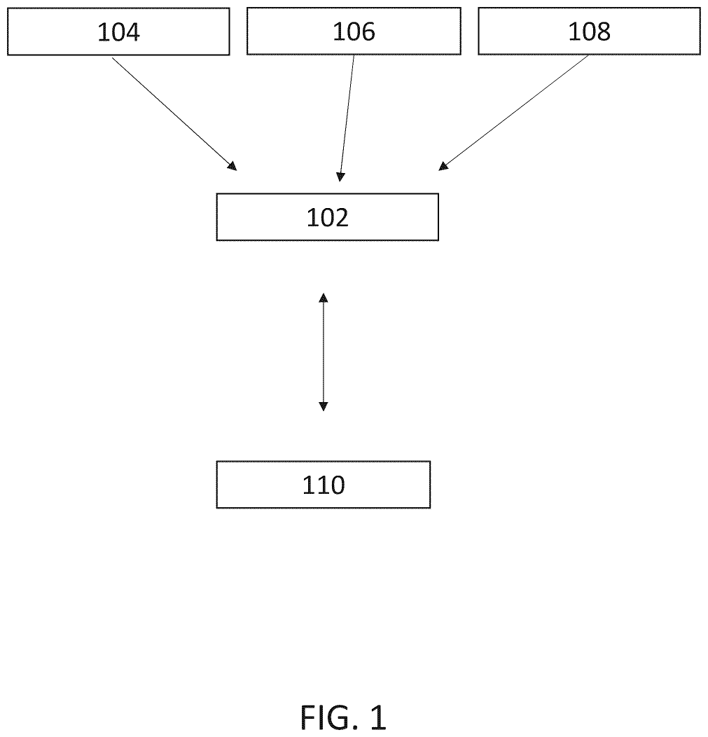

FIG. 1 illustrates a schematic diagram of a gaming matchmaking system according to an embodiment of the present disclosure. The gaming matchmaking system includes a software platform 102 designed to collect and monitor gaming activity for a plurality of users. Gaming activity includes user data 104, matchmaking data 106, and gameplay data 108. For example, and without limitation, user data includes age, types of games played, amount of time spent on each played game, ranks in each played game, type of gaming console, and input method (e.g., controller or keyboard). The gameplay data includes game types (e.g., objective-based or kill-based), gaming objectives, gaming environments, and interactions with the gaming environment.

In some embodiments, the gaming matchmaking system is in network communication with a plurality of remote devices 110. The plurality of remote devices includes, but is not limited to, gaming consoles, computers, cell phones, and other network enabled devices. In some embodiments, the gaming matchmaking system is in network communication with gaming service providers including Steam, Epic Games Store, Blizzard, Ubisoft, Electronic Art store, and other similar platforms.

In some embodiments, the gaming matchmaking system is operable to receive user input via at least one remote device. For example, and not limitation, the user input includes a game selection, a game mode selection, team size, rank level, and a style of gameplay. Based on the user input, the gaming matchmaking system is operable to determine at least one compatible teammate. In some embodiments, the gaming matchmaking system determines at least one compatible teammate based on similarities and differences between player profiles. Advantageously, the gaming matchmaking system is operable to receive a plurality of user inputs and to match players based on the plurality of user inputs. For example, the user input may include objective for game mode and aggressiveness for playstyle and also include passive for battle royale and other survival game modes. The gaming matchmaking system is operable to recommend at least one player that matches the objective playstyle, at least one player that matches the survival playstyle, and/or at least one player that matches both the objective playstyle and the survival playstyle.

In some embodiments, the gaming matchmaking system includes a matchmaking algorithm. The matchmaking algorithm is designed to match a player with one or more players of similar rank. For example, and without limitation, if a player is a “bronze” level, then the matchmaking algorithm is designed to only match the player with other bronze level player. In some embodiments, the matchmaking algorithm is designed to include players at least one rank above or below a player's rank. For example, the matchmaking algorithm can have both bronze and silver players in the same game. For further example, and not limitation, in some embodiments, the matchmaking ranks include bronze, silver, gold, diamond, elite, champion, and unreal. The matchmaking algorithm is operable to match players corresponding to the player's exact rank, to ranks within at least one level of the player's rank, and/or within a predetermined amount of experience.

In some embodiments, the matchmaking algorithm combines an overall level (e.g., bronze) with a second ranking (e.g., division, skill rating, amount of experience points). For example, and without limitation, if a first user has a ranking of gold 3, division 3 (3 being the highest division), then the algorithm is operable to match the first user with a second user that is within a predetermined or desired threshold. For example, the predetermined threshold includes at least two divisions. The gaming matchmaking system is operable to only match the first user with a player that is gold 3 division 3 and platinum division 1.

In some embodiments, the matchmaking system matches a player based on the player's self-assessment. For example, and not limitation, a first-time player will be matched with other first-time players, an intermediate player will be matched with other intermediate players, a professional will be matched with other professionals, and a legend will be matched with another legend.

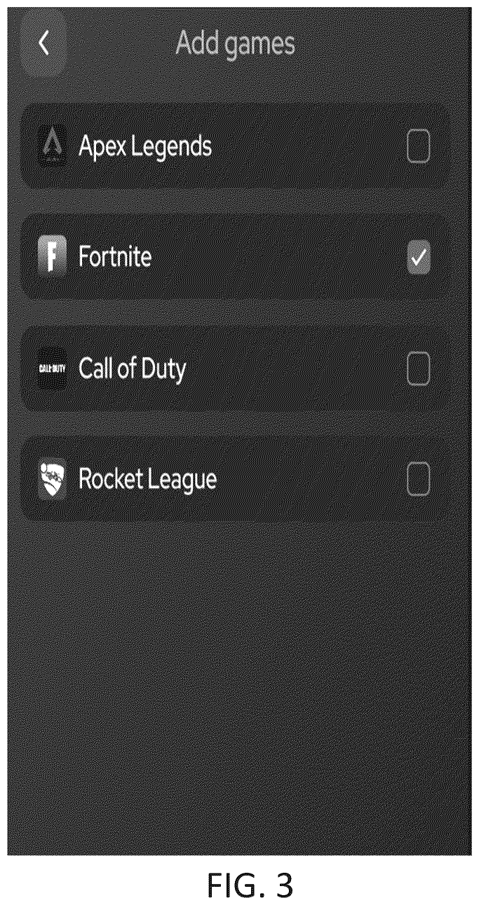

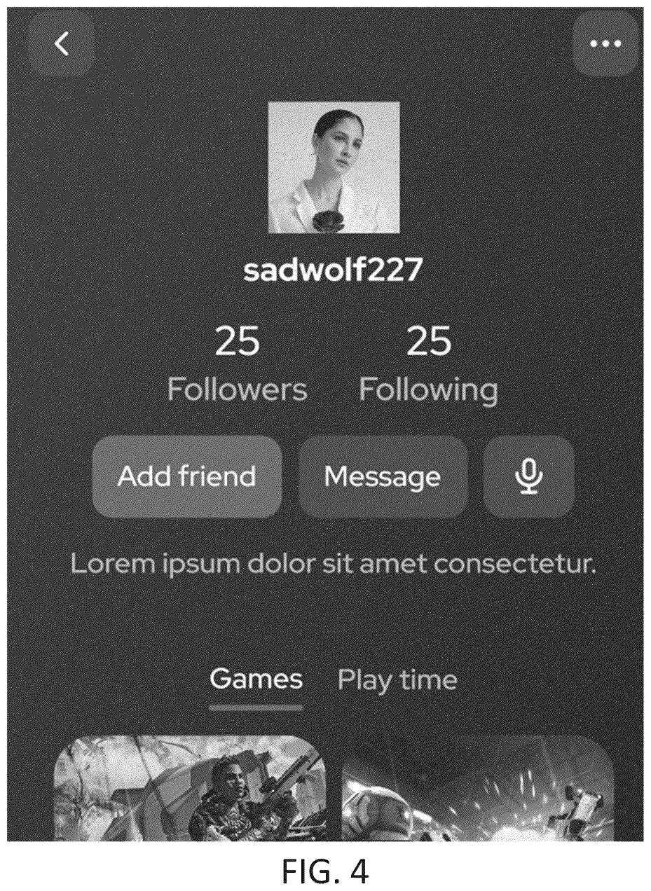

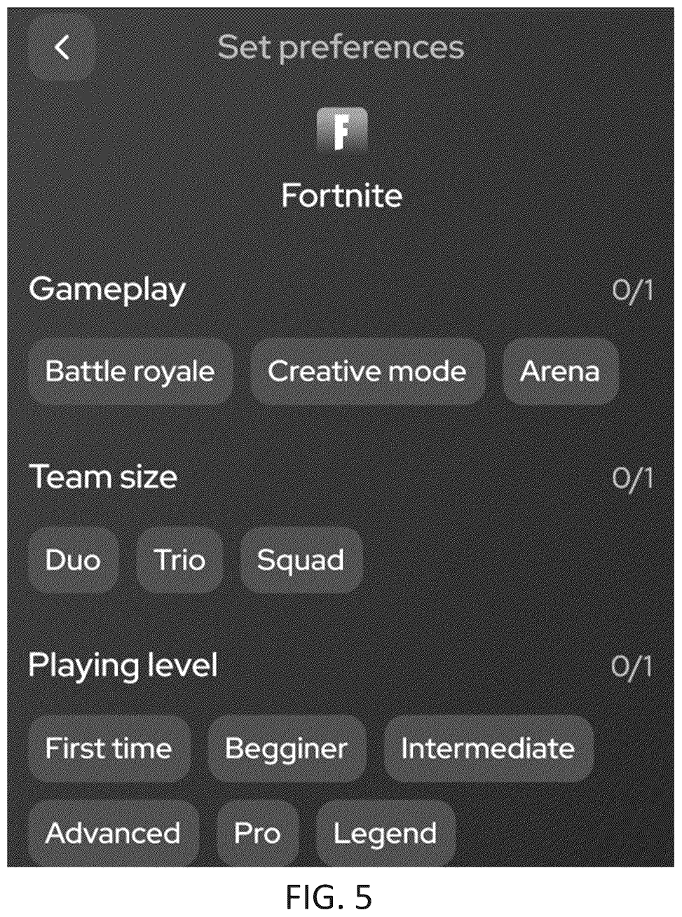

In some embodiments, the gaming matchmaking system includes a software application displayable via a remote device. For example, and not limitation, the software application is displayed via a user interface of a cellphone. As shown in FIG. 3, the software application is operable to receive user input relating to a type of game. FIG. 4 illustrates a user profile dashboard according to one embodiment of the gaming matchmaking system. FIG. 5 illustrates a gaming preferences dashboard according to one embodiment of the gaming matchmaking system.

The gaming matchmaking system can receive user input and suggest potential teammates based on the user input. The gaming matchmaking system is further designed to directly form groups within a video game. For example, and without limitation, the gaming matchmaking system is operable to receive a team request from a first user for a second user and transmit the team request to a remote device (e.g., cellphone, gaming console) corresponding to the second user. Advantageously, the team request is acceptable via the gaming console and can automatically link the first user and the second user in the corresponding game. This enables real-time group formation and allows for seamless team formation.

For further example, and without limitation, in some embodiments, the gaming matchmaking system is operable to work with Fortnite. The gaming matchmaking system is operable to receive user input including at least one game mode selection, at least one team size, and at least one rank level. For further example and not limitation, the game mode selection may include battle royal, arena, and/or creative mode. The team size includes duos, trios, and/or squads. The selection of skill level includes beginner, intermediate, advanced, pro, legend. The playstyle selection includes aggressiveness preference, looting preference, and rotation preference. For example, and not limitation, the rotation preference includes center of a zone, hunting other players, or staying on the edge of a zone.

For further example, and without limitation, the gaming matchmaking system is operable to receive user input including first-time player, a battle royale game selection, a duos team size, an aggressive play style, and a chase to kill rotation style. The gaming matchmaking system is further operable to match with a second user that includes similar inputs.

In some embodiments, the gaming matchmaking system is used for sport-based video games. For example, and not limitation, the gaming matchmaking system is configured for Rocket League matchmaking. The gaming matchmaking system is operable to receive user input including at least one game mode selection, at least one team size, and at least one rank level. For example, and not limitation, the game mode selection includes casual, ranked, tournament, hoops, snow-day, dropshot, and rumble. The gameplay selection includes duos, trios, and quads. The gameplay style includes offensive scorer, offensive passer, mid scorer, scorer, defender, passer, defensive passer, defensive scorer, and mid defender. The gameplay style includes aggressive, solo play, passer, anchor, demo-heavy, and other characteristics. The rank level includes unranked, bronze silver, gold, platinum, diamond, champ, grand champ, and supersonic legend.

In some embodiments, the gaming matchmaking system can broaden matchmaking criteria to improve user experience. For example, and without limitation, if a beginner (e.g., unranked, bronze, silver) is having difficulty finding matches (e.g., long wait times), the search parameters will expand to intermediate players (e.g., Gold, platinum). In some embodiments, the search parameters extend to a predetermined range. For example, and without limitation, if a gold 1 division 1 player is searching for matches, the algorithm will search for silver 3 division 2 to gold 3 division 3 players. The gaming matchmaking system will verify a user rank utilizing matchmaking and user data. For further example, and without limitation, the matchmaking algorithm is operable to match offensive players with defensive players. When searching for trios, the matchmaking algorithm is operable to search for an offensive player, a defensive player, and a balanced player.

For further example, in some embodiments, the matchmaking algorithm is designed to give a user matchmaking score based on (1) self-assessment, (2) game mode, (3) team size, (4) in-game playstyle, and (5) play style. In some embodiments, the user matchmaking score is out of 1. Self-assessment can be worth about 40% of the user matchmaking score, game mode can be worth about 30% of the user matchmaking score, in-game playstyle can be worth about 20% of user matchmaking score, and playstyle can be worth about 10% of user matchmaking score. The weighted percentage with these variables can be adapted as necessary to improve matchmaking. The user matchmaking score may comprise other variables based on a user profile and/or gameplay data. The self-assessment can include a rank and/or skill tier. The rank and/or skill tier may include unranked, Bronze I-III, Silver I-III, Gold I-III, Diamond I-III, Champion I-III, Grand Champion I-III, or supersonic legend. The game mode includes causal modes, ranked modes, and/or extra mode. In-game playstyle includes offensive, defensive, and balanced players. Playstyle criteria includes, but is not limited to, demo-heavy, aggressive, and other similar characteristics. When searching for users, the matchmaking algorithm first identifies users with identical scores. If a user with an identical score cannot be determined, then the search criteria can be expanded to users within 0.2 of the original user matchmaking score. For further example, the gaming matchmaking system can increase the range of acceptable scores based on a queue time, desired difficulty, and other factors that affect matchmaking and user experience. For example, the gaming matchmaking system can first increase a range of acceptable matchmaking scores to be within 20% of a targeted user score. If the gaming matchmaking system has difficulty (e.g., wait time over one minute) finding other users, the gaming matchmaking system can increase the range of acceptable matchmaking scores to at least 50% of a targeted user score.

In some embodiments, the gaming matchmaking system is configured to improve matchmaking for a first-person shooter video game (e.g., Apex Legends). The gaming matchmaking system is operable to receive user input including at least one game mode selection, at least one team size, and at least one rank level. The rank level includes first time, beginner, intermediate, pro, and legend. The game mode includes ranked, battle royale, firing squad, and mixtape matches (e.g., team deathmatch, control). The team size includes duos and trios. The gameplay and rotation include aggressive, passive, chase to kill, stay in the center of the circle, and stay on the edge of a circle.

In some embodiments, the gaming matchmaking system is configured to determine matchmaking for a first-person shooter video game (e.g., Call of Duty). The gaming matchmaking system is operable to receive user input including at least one game mode selection, at least one team size, at least one rank level, at least one gameplay style, and at least one rotation style. The rank level includes first time, beginner, intermediate, pro, and legend. The game mode includes ranked, battle royale (e.g., Warzone), and quickplay matches (e.g., team deathmatch, headquarters). The team size includes duos and/or trios. The gameplay style includes, but is not limited to, aggressive or passive. The rotation style includes, but is not limited to, chase to kill, stay in the center of the circle, and stay on the edge of a circle.

In some embodiments, the gaming matchmaking algorithm is configured for matchmaking for a third-person shooter game (e.g., Fortnite). The gaming matchmaking algorithm is designed to utilize user data to determine ideal matches to improve user matchmaking experience. The user data includes self-assessment, game mode, multiplayer size, in-game movement, and playstyle. For example, and without limitation, a user profile has a “Chase to Kill” playstyle, the gaming matchmaking algorithm can initially look for players that also have a “Chase to Kill” playstyle. If the gaming matchmaking algorithm cannot find a player with a “Chase to Kill” playstyle, then the gaming matchmaking algorithm can expand to players that have a “Center Circle” or “Zone Walk” playstyle.

In some embodiments, the gaming matchmaking system receives gaming metadata. For example, and without limitation, the gaming metadata includes gaming platform, gaming genre, gaming style, gameplay data, gameplay theme, gameplay mood, system requirements, developer, format, number of players, point of view, customization options, difficulty, language, region, rating, and any other metadata capture by gaming platforms. The gaming matchmaking system is designed to correlate the gaming metadata with gameplay data, matchmaking data, and/or user data to optimize matchmaking recommendations.

Advantageously, the gaming matchmaking system is operable to monitor gameplay based on the game mode. For example, and not limitation, in casual and ranked modes, the gaming matchmaking system is operable to monitor the aggressive nature of a player, the amount of goals (e.g., quality of goals (placement/defenders in proximity)), the amount and quality of passes, and the amount and quality of saves. In some embodiments, the gaming matchmaking system creates a matchmaking score for each game mode and provides a matchmaking recommendation for each game mode. The corresponding matchmaking score is adjusted based on the differing playstyle, objectives, teammates, and other factors that may affect gameplay.

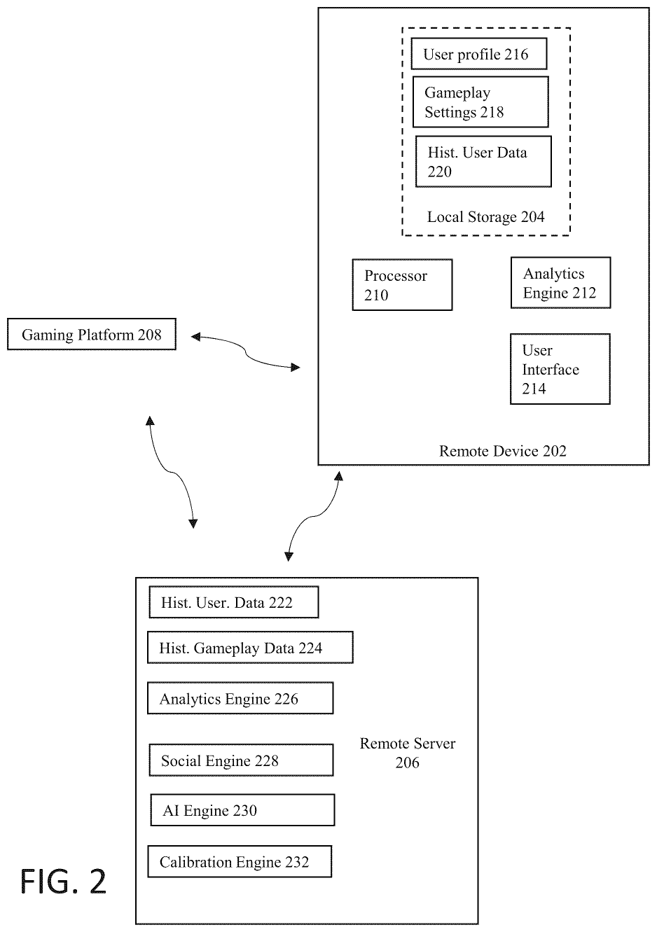

FIG. 2 is a block diagram of an embodiment of the gaming matchmaking system. The gaming matchmaking system 200 includes a remote device 202 with local storage 204, a remote server 206, and a gaming platform 208. The gaming matchmaking system captures and/or receives user data and gameplay data and provides matchmaking feedback and suggestions based on the user data and gameplay data.

The remote device 202 may be any device operable for network communication. The remote device can include a mobile phone, a desktop, a personal computer, a gaming console, and/or other remote device operable for operating a software application. The remote device includes a processor 210, an analytics engine 212, and a user interface 214. The remote device 202 receives data via user input and/or from the at least one remote server 206 and/or gaming console 208. The remote device can store data in the local storage 204.

The local storage 204 includes a user profile data 216, gameplay settings 218, and historical user data 220. The user profile 216 can include user preferences, a communication method (e.g., headset, call, chat), a region (e.g., North America, Europe, Africa, Asia, Oceania), an audio introduction (e.g., uploaded user voice), and profile picture (e.g., virtual avatar). The profile data includes user statistics corresponding to playtime, video clips, achievements, and other similar gaming data. The gameplay settings include input method, display settings, and other settings related to playing video games. The historical user data includes games played, amount of time played, previous ranks, and other gameplay-related data.

The remote server 206 includes historical user data 222, historical gameplay data 224, an analytics engine 226, a social engine 228, an artificial intelligence engine 230, and a calibration engine 232. The historical user data 222 and historical gameplay data 224 include data corresponding to a plurality of users and gaming platforms.

The artificial intelligence engine is operable to receive real-time, near real-time, and historical gameplay data, user data, matchmaking data, and corresponding metadata. The artificial intelligence engine includes a visualization component for displaying the captured and analyzed real-time, near real-time, and/or historical gameplay data. The artificial intelligence engine is operable to generate a coaching recommendation based on user gameplay. For example, and without limitation, the artificial intelligence engine is operable to receive user gameplay data corresponding to Rocket League. The gameplay includes movement data, positioning data, and other gameplay data corresponding to at least one Rocket League match. The artificial intelligence engine is operable to compare the movement data, positioning data, boost management data, and speed data for other players. In some aspects, the artificial intelligence engine analyzes a target user performance to user performance of other players in the same match. In some aspects, the artificial intelligence engine compares user gameplay data to users with similar ranks, playstyles, and other characteristics related to the gameplay. The artificial intelligence engine can further compare user performance against similar opponents. After analyzing the gameplay data, the artificial intelligence engine is operable to generate a coaching recommendation including (1) rotate back post, (2) work on speed acrials, (3) collect small boost pads instead of going for large boost pads, and other analysis relevant to the user's gameplay.

The coaching recommendation can be game-specific but can also be related to multiple games. For example, and without limitation, the artificial intelligence engine is operable to track user behavior for a plurality of first-person shooter (FPS) games. Based on user mouse movement and weapon accuracy, the artificial intelligence engine is designed to suggest whether a user should increase or decrease a dots per inch (DPI) corresponding to a user's mouse. The artificial intelligence engine is further operable to recommend changes to user settings. For example, and without limitation, if a user is using a wireless controller, the artificial intelligence engine may suggest switching to a wired connection to reduce input latency. For further example, the artificial intelligence engine is operable to detect that a user is experiencing significant latency (e.g., greater than 100 ping) during online matchmaking and confirm whether a user is connected to a proper server based on the user location. If the artificial intelligence engine further detects that the user is experiencing issues that are not directed related to user gameplay, the artificial intelligence engine is designed to not affect a matchmaking score.

The artificial intelligence engine may include a plurality of artificial intelligence learning techniques including, but not limited to, machine learning (ML), regression, classification, transfer learning, clustering, natural language processing (NLP), computer vision, deep learning, dimensionality reduction, word embeddings, support vector machines and reinforcement learning.

In some embodiments, the gaming matchmaking system is operable to receive user input via at least one remote device. For example, and not limitation, the user input includes a game selection, a game mode selection, team size, rank level, and a style of gameplay. Based on the user input, the gaming matchmaking system is operable to determine at least one compatible teammate. In some embodiments, the gaming matchmaking system determines at least one compatible teammate based on similarities and differences between player profiles. Advantageously, the gaming matchmaking system is operable to receive a plurality of user inputs and to match players based on the plurality of user inputs. For example, the user input may include objective for game mode and aggressiveness for playstyle and also include passive for battle royale and other survival game modes. The gaming matchmaking system is operable to recommend at least one player that matches the objective playstyle, at least one player that matches the survival playstyle, and at least one player that matches both the objective playstyle and the survival playstyle. The game matchmaking system can modify at least one compatible teammate based on gameplay data. For example, and without limitation, a user input may include a passive playstyle, however, utilizing the gameplay data, the gaming matchmaking system is operable to determine that a user has an aggressive playstyle. The gaming matchmaking system is operable to automatically update a user profile and to modify a compatible teammate recommendation.

In some embodiments, the gaming matchmaking system includes a matchmaking algorithm. The matchmaking algorithm is designed to match a player with one or more players of similar rank. For example, and not limitation, if a player is a “bronze” level, then the matchmaking algorithm is designed to only match the player with other bronze level player. In some embodiments, the matchmaking algorithm is designed to include players at least one rank above or below a player's rank. For example, the matchmaking algorithm can have both bronze and silver players in the same game. For further example, and not limitation, in some embodiments, the matchmaking ranks include bronze, silver, gold, diamond, elite, champion, and unreal. The matchmaking algorithm is operable to match players corresponding to the player's exact rank, to ranks within at least one level of the player's rank, and/or within a predetermined amount of experience.

In some embodiments, the matchmaking algorithm combines an overall level (e.g., bronze) with a second ranking (e.g., division, skill rating, amount of experience points). For example, and without limitation, if a first user has a ranking of gold 3, division 3 (3 being the highest division), then the algorithm is operable to match the first user with a second user that is within a predetermined or desired threshold. For example, the predetermined threshold includes at least two divisions. The gaming matchmaking system is operable to only match the first user with a player that is gold 3 division 3 and platinum division 1.

In some embodiments, the gaming matchmaking system matches a player based on the player's self-assessment. For example, and not limitation, a first-time player will be matched with other first-time players, an intermediate player will be matched with other intermediate players, a professional will be matched with other professionals, and a legend will be matched with another legend.

For further example, in some embodiments, the matchmaking algorithm is designed to give a user score based on (1) self-assessment, (2) game mode, (3) team size, (4) in-game playstyle, and (5) play style. In some embodiments, the user score is out of 1. Self-assessment includes about 40% of the user matchmaking score, the game mode includes 30% of a user matchmaking score, in-game playstyle includes 20% of the user matchmaking score, and playstyle includes about 10% of a user matchmaking score. The self-assessment includes a rank and/or skill tier. The rank and/or skill tier may include unranked, Bronze I-III, Silver I-III, Gold I-III, Diamond I-III, Champion I-III, Grand Champion I-III, or supersonic legend. The game mode includes causal modes, ranked modes, and/or extra mode. In-game playstyle includes offensive defense, and balanced players. Playstyle criteria may include demo-heavy, aggressive and other similar characteristics. When searching for users, the matchmaking algorithm first identifies users with identical scores. If a user with an identical score cannot be determined, then the search criteria is expanded to users within 0.2 of the original score.

The calibration engine 232 can update the parameters used for generating matchmaking scores and evaluating players. For example, and without limitation, when a game undergoes updates that affect gameplay (e.g., character skills, maps), the calibration engine adjusts how to evaluate players. For example, if a user's most played character changes from a damage per second (DPS) role to a support role that requires more collaborative gameplay, the calibration engine is operable to change a user profile to support and team-oriented. Advantageously, this provides real-time or near real-time adjustments that maintain proper matchmaking.

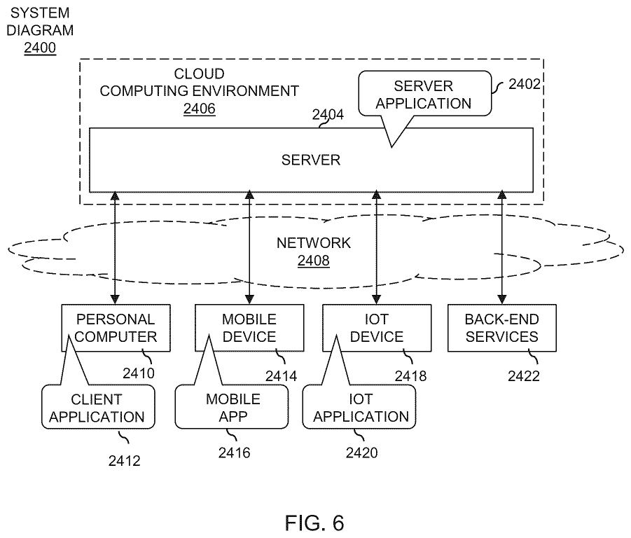

FIG. 6 depicts a system diagram 2400 illustrating a client/server architecture in accordance with embodiments of the present disclosure. The server application 2402 is configured to provide a video application and mobile application for an online gaming matchmaking system. A server application 2402 is hosted on a remote server 2404 within a cloud computing environment 2406. The server application 2402 is provided on a non-transitory computer-readable medium including a plurality of machine-readable instructions, which when executed by one or more processors of the server 2404, are adapted to cause the server 2404 to generate the video platform and mobile application.

The server application 2402 is configured to communicate over a network 2408. In a preferred embodiment, the network 2408 is the Internet. In other embodiments, the network 2408 may be restricted to a private local area network (LAN) and/or private wide area network (WAN). The network 2408 provides connectivity with a plurality of client devices including a personal computer 2410 hosting a client application 2412, a mobile device 2414 hosting a mobile app 2416. The network 2408 also provides connectivity for an Internet-Of-Things (IoT) device 2418 hosting an IoT application 2420, and to back-end services 2422. Advantageously, the back-end services are operable to communicate with third-party application programming interfaces (APIs) to either provide or receive data that can be used by the system to provide recommendations. Third-party applications provide algorithms for analysis of data. The back-end services may provide data gathered within the gaming matchmaking system through the third-party APIs and receives results from the algorithms provided back to the back-end services to provide further recommendations or take further actions within the gaming matchmaking system.

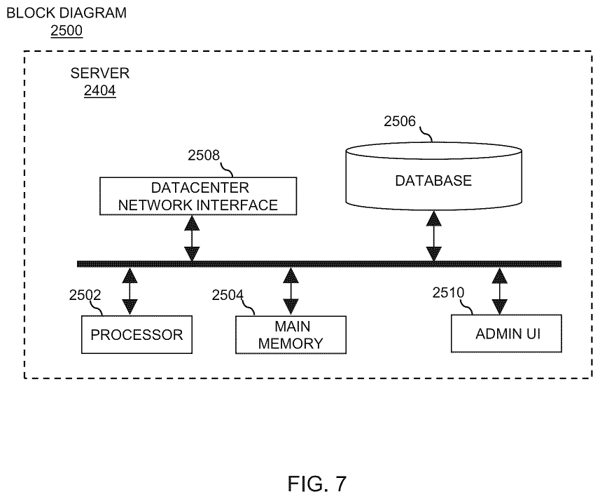

FIG. 7 depicts a block diagram 2500 of the server 2404 of FIG. 6 for hosting at least a portion of the server application 2402 of FIG. 6 in accordance with embodiments of the present disclosure. The server 2404 may be any of the hardware servers referenced in this disclosure. The server 2404 may include at least one of a processor 2502, a main memory 2504, a database 2506, a datacenter network interface 2508, and an administration user interface (UI) 2510. The server 2404 may be configured to host one or more virtualized servers. For example, the virtual server may be an Ubuntu® server or the like. The server 2404 may also be configured to host a virtual container. For example, the virtual server may be the DOCKER® virtual server or the like. In some embodiments, the virtual server and or virtual container may be distributed over a plurality of hardware servers using hypervisor technology.

The processor 2502 may be a multi-core server class processor suitable for hardware virtualization. The processor 2502 may support at least a 64-bit architecture and a single instruction multiple data (SIMD) instruction set. The memory 2504 may include a combination of volatile memory (e.g., random access memory) and non-volatile memory (e.g., flash memory). The database 2506 may include one or more hard drives.

The datacenter network interface 2508 may provide one or more high-speed communication ports to the data center switches, routers, and/or network storage appliances. The datacenter network interface may include high-speed optical Ethernet, InfiniBand (IB), Internet Small Computer System Interface iSCSI, and/or Fibre Channel interfaces. The administration UI may support local and/or remote configuration of the server by a data center administrator.

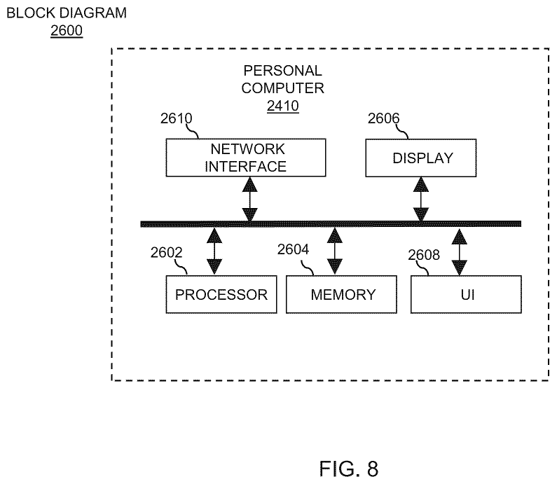

FIG. 8 depicts a block diagram 2600 of the personal computer 2410 of FIG. 6 in accordance with embodiments of the present disclosure. The personal computer 2410 may be any of the devices referenced in this disclosure. The personal computer 2410 may include at least a processor 2602, a memory 2604, a display 2606, a user interface (UI) 2608, and a network interface 2610. The personal computer 2410 may include an operating system to run a web browser and/or the client application 2412 shown in FIG. 6. The operating system (OS) may be a Windows® OS, a Macintosh® OS, or a Linux® OS. The memory 2604 may include a combination of volatile memory (e.g., random access memory) and non-volatile memory (e.g., solid state drive and/or hard drives).

The network interface 2610 may be a wired Ethernet interface or a Wi-Fi interface. The personal computer 2410 may be configured to access remote memory (e.g., network storage and/or cloud storage) via the network interface 2610. The UI 2608 may include a keyboard, and a pointing device (e.g., mouse). The display 2606 may be an external display (e.g., computer monitor) or internal display (e.g., laptop). In some embodiments, the personal computer 2410 may be a smart TV. In other embodiments, the display 2606 may include a holographic projector.

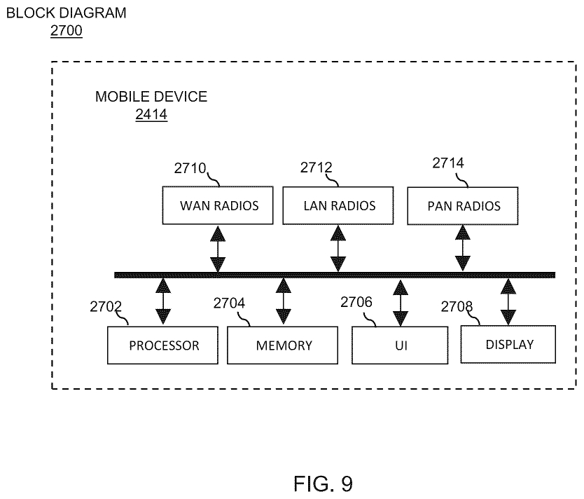

FIG. 9 depicts a block diagram 2700 of the mobile device 2414 of FIG. 6 in accordance with embodiments of the present disclosure. The mobile device 2414 may be any of the remote devices referenced in this disclosure. The mobile device 2414 may include an operating system to run a web browser and/or the mobile app 2416 shown in FIG. 6. The mobile device 2414 may include at least a processor 2702, a memory 2704, a UI 2706, a display 2708, WAN radios 2710, LAN radios 2712, and personal area network (PAN) radios 2714. In some embodiments the mobile device 2414 may be an iPhone® or an iPad®, using iOS® as an OS. In other embodiments the mobile device 2414 may be a mobile terminal including Android® OS, BlackBerry® OS, Chrome® OS, Windows Phone® OS, or the like.

In some embodiments, the processor 2702 may be a mobile processor such as the Qualcomm® Snapdragon™ mobile processor. The memory 2704 may include a combination of volatile memory (e.g., random access memory) and non-volatile memory (e.g., flash memory). The memory 2704 may be partially integrated with the processor 2702. The UI 2706 and display 2708 may be integrated such as a touchpad display. The WAN radios 2710 may include 2G, 3G, 4G, and/or 5G technologies. The LAN radios 2712 may include Wi-Fi technologies such as 802.11a, 802.11b/g/n, and/or 802.11ac circuitry. The PAN radios 2714 may include Bluetooth® technologies.

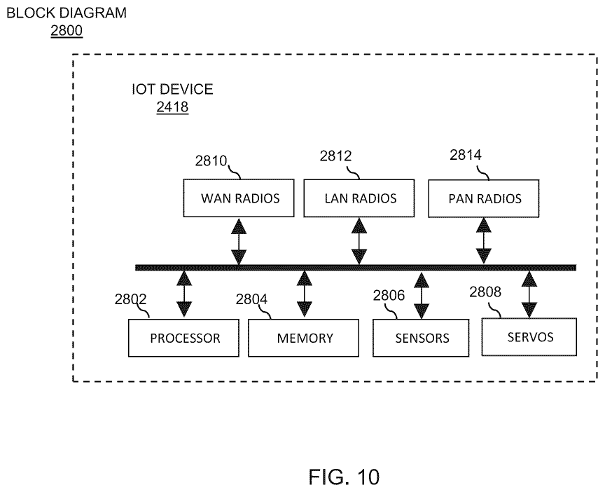

FIG. 10 depicts a block diagram 2800 of the IoT device 2418 of FIG. 6 in accordance with embodiments of the present disclosure. The IoT device 2418 may be any of the remote devices referenced in this disclosure. The IoT device 2418 includes a processor 2802, a memory 2804, sensors 2806, servos 2808, WAN radios 2810, LAN radios 2812, and PAN radios 2814. The processor 2802, a memory 2804, WAN radios 2810, LAN radios 2812, and PAN radios 2814 may be of similar design to the processor 2702, a memory 2704, WAN radios 2710, LAN radios 2712, and PAN radios 2714 of the mobile device 2414 of FIG. 7. The sensors 2806 and servos 2808 may include any applicable components related to IoT devices such as a monitoring device, a smart appliance, a virtual reality device, an augmented reality device, or the like.

Any combination of one or more computer-readable medium(s) may be utilized. The computer-readable medium may be a computer-readable signal medium or a computer-readable storage medium (such as non-transitory computer-readable storage media). A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer-readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including object oriented and/or procedural programming languages. Programming languages may include, but are not limited to: Ruby®, JavaScript®, Java®, Python®, PHP, C, C++, C#, Objective-C®, Go®, Scala®, Swift®, Kotlin®, OCaml®, or the like. The program code may execute entirely on the user's computer, partly on the user's computer, as a stand-alone software package, partly on the user's computer, and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the embodiments in the form disclosed. Many modifications and variations will be apparent to those of ordinary skill in the art without departing from the scope and spirit of the present disclosure. The embodiment was chosen and described in order to best explain the principles of the present disclosure and the practical application, and to enable others of ordinary skill in the art to understand the present disclosure for various embodiments with various modifications as are suited to the particular use contemplated.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A gaming matchmaking system comprising:
at least one remote device; and
a computer system communicatively coupled to the at least one remote device, the computer system comprising a memory and at least one processor;
wherein the at least one processor is configured for:
receiving, from the at least one remote device, user data and gameplay data associated with at least one user;
associating the user data with the gameplay data;
generating a matchmaking score based on the association of the user data with the gameplay data; and
recommending at least one other user based on the matchmaking score.

2. The gaming matchmaking system of claim 1, wherein the user data includes type of games played, amount of time played per game, a rank for each game, a rank for each game mode, and/or types of roles.

3. The gaming matchmaking system of claim 1, wherein the gameplay data includes audiovisual data and metadata corresponding to the audiovisual data.

4. The gaming matchmaking system of claim 3, wherein the metadata corresponding to the audiovisual data includes gaming platform, gaming style, system requirements, controller settings, and/or difficulty level.

5. The gaming matchmaking system of claim 1, wherein the at least one processor is further configured to generate at least one gameplay recommendation based on the user data and the gameplay data, wherein the at least one gameplay recommendation includes a controller recommendation, a playstyle recommendation, and/or an equipment recommendation.

6. A multiplayer matchmaking system comprising:
at least one remote device including a user interface;
at least one gaming platform; and
at least one remote server including a software platform including an analytics engine and at least one database;
wherein the at least one remote device, the at least one gaming platform, and the at least one remote server are in network communication;
wherein the at least one remote device is operable to receive user input;
wherein the at least one gaming platform is operable to capture gameplay data corresponding to at least one user, wherein the gameplay data is transmitted to the at least one remote device and the at least one remote server;
wherein, after receiving the user gameplay data, the analytics engine of the at least one remote server is designed to analyze the user gameplay data and the user input data to determine a matchmaking score; and
wherein, based on the matchmaking score, the analytics engine is operable to suggest at least one matchmaking recommendation.

7. The multiplayer matchmaking system of claim 6, wherein the at least one matchmaking recommendation includes profile information corresponding to at least one other user.

8. The multiplayer matchmaking system of claim 6, wherein the analytics engine is further operable to generate a gameplay recommendation.

9. The multiplayer matchmaking system of claim 8, wherein the gameplay recommendation includes a playstyle recommendation, and/or a setting recommendation.

10. The multiplayer matchmaking system of claim 6, wherein the at least one remote device and the at least one gaming platform are operable to receive the at least one matchmaking recommendation from the at least one remote server, wherein the at least one remote device is further operable to identify another user corresponding to the at least one matchmaking recommendation, wherein the at least one remote device automatically creates a messaging request.

11. The multiplayer matchmaking system of claim 6, wherein the at least one remote server is operable to receive real-time gameplay data corresponding to the at least one user, wherein the analytics engine is operable to automatically update the matchmaking score based on the real-time gameplay data.

12. The multiplayer matchmaking system of claim 11, wherein the analytics engine is further operable to generate a teammate recommendation based on the updated matchmaking score.

13. The multiplayer matchmaking system of claim 6, wherein the at least one remote server further comprises an artificial intelligence engine, wherein the artificial intelligence engine is operable to generate at least one coaching recommendation based on user gameplay data.

14. The multiplayer matchmaking system of claim 6, wherein the analytics engine generates the matchmaking score based on a user self-assessment, a game mode selection, a number of players, an in-game playstyle, and/or a playstyle preference.

15. The multiplayer matchmaking system of claim 6, wherein the gameplay data includes movement data, positioning data, result data, and/or equipment data.

16. The multiplayer matching system of claim 6, wherein the at least one matchmaking recommendation includes at least one teammate recommendation and/or at least one opponent recommendation.

17. The multiplayer matchmaking system of claim 6, wherein the gameplay data includes audiovisual data and metadata corresponding to the audiovisual data.

18. The multiplayer matchmaking system of claim 17, wherein the metadata corresponding to the audiovisual data includes gaming platform, gaming style, system requirements, controller settings, and/or difficulty level.

19. The multiplayer matchmaking system of claim 6, wherein the at least one remote device and the at least one gaming platform are operable to receive the at least one matchmaking recommendation from the at least one remote server, wherein the at least one remote device is further operable to identify another user corresponding to the at least one matchmaking recommendation, wherein the at least one gaming console automatically adds the identified user to a team corresponding to the at least one user.

20. The multiplayer matchmaking system of claim 19, wherein the at least one remote server is further operable to identify a third user based on the at least one matchmaking recommendation, wherein the at least one gaming console automatically adds the third user to an opposing team of the at least one user.
